(19) United States
(12) Patent Application Publication
(10) Pub. No.: US 2020/0065827 A1
(43) Pub. Date: Feb. 27, 2020

(54) PROJECTION SCREEN ANTICOUNTERFEITING SYSTEM AND METHOD OF IMPLEMENTATION THEREOF

(71) Applicant: LUMINIT LLC, Torrance, CA (US)

(72) Inventors: Thomas C. Forrester, Torrance, CA (US); A. Alkan Gulses, Torrance, CA (US); Seth Coe-Sullivan, Torrance, CA (US); Anthony Ang, Torrance, CA (US); Russell M. Kurtz, Torrance, CA (US); Juan Russo, Torrance, CA (US)

(21) Appl. No.: 16/549,876

(22) Filed: Aug. 23, 2019

Related U.S. Application Data
(60) Provisional application No. 62/722,284, filed on Aug. 24, 2018.
(60) Provisional application No. 62/722,245, filed on Aug. 24, 2018.

(51) Int. Cl. G06Q 30/00; G03B 21/56; G03H 1/00; G06K 7/10

(52) U.S. Cl. CPC G06Q 30/0185; G03B 21/56; G03H 1/0011; A63J 25/00; G06K 7/1094; G03H 2001/0016; G06K 7/10861

(57) ABSTRACT

The present disclosure provides an anticounterfeiting system based on optical technology that verify the authenticity of protected cinema screens. The optical technology includes taggants embedded or attached to the screen and an optical readout system that can interrogate the taggant layer and receive the taggant output. The taggants are capable of reflecting a pattern that unambiguously demonstrates that the screen contains the taggant. The taggants are covert because they are not visible under normal lighting conditions or during cinema operation, but are detected when interrogated by the optical readout system.

### CROSS-REFERENCE TO RELATED APPLICATION

This application claims priority to U.S. Provisional Patent Application Ser. Nos. 62/722,245 and 62/722,284, both filed Aug. 24, 2018, whose disclosures are incorporated herein by reference.

### TECHNICAL FIELD

This application pertains to the field of optics, more particularly optically responsive materials as applied to anticounterfeiting. An embodiment discussed herein applies specifically to anticounterfeit marking of projection cinema screens.

### BACKGROUND

There is a huge public demand for projection cinema screens, which can be used as electronic viewing spaces at a home, at a business, at a cinema theater, at an outdoor concert venue, and many other locations. In view of these diverse consumer environments, there are a wide assortment of screens available, which are made of a variety of materials and have a broad range of features as well as prices. Notably, screen quality is a major factor in both the cost of production and the selling price of the screen, so screen manufacturers are very interested in protecting their designs and merchandise from being copied and sold without permission.

As with many other popular consumer goods, counterfeiting of these projection screens has become a significant world-wide problem. Although some of the screens have designs and markings for identification purposes, most of those designs can be easily copied by other parties. In this unfortunate situation, the unknowing purchasers of the counterfeit goods receive a lower-performance screen than the genuine screen they wanted; the certified manufacturer loses sales and gains a tarnished reputation for allegedly providing lower quality goods; and the overall market loses the clarity that connects a specific screen to a specific performance. Therefore, an optically-responsive anticounterfeiting system and a method for detecting counterfeit screens are critically needed. This application addresses those critical needs.

### SUMMARY

Provided herein is a novel anticounterfeiting system for projection screens. The system employs an anticounterfeiting taggant that includes an optically-active layer of material patterned with a design, a code, or an image. The taggant can be embedded in or attached to the projection screen and can be detected by the use of a certain unique light that is matched to the taggant's specific optics. The system has a light source capable of providing a matching coded optical stimulus with respect to the taggant. The system also includes a detector capable of detecting the image output.

In a method for authenticating a projection screen, an optical taggant can be interrogated with a coded optical stimulus matching the taggant from the light source to provide a coded optical response that is registered by the detector to authenticate the screen. The taggant is unique to the screen manufacturer.

The taggant can be at least one fluorescent dye, fluorescent ink, fluorescent particle, or mixtures thereof or can be a computer-generated hologram (CGH) or both a fluorescent moiety and a CGH.

Another embodiment is the use of multiple fragments of a CGH as a taggant, which fragments can be placed randomly or in a predetermined pattern in or on the screen. The CGH fragments themselves can include a unique pattern as well.

The anticounterfeiting taggant can be added during the screen fabrication process, or can be added later. The positioning and design of the anticounterfeiting taggant can be selected to avoid any change in the optical, physical, or acoustic performance of the screen.

### BRIEF DESCRIPTION OF THE DRAWINGS

FIG. 1 shows an example of a surface with embedded CGH taggants, the taggant surfaces, and the optical output that occurs when they are illuminated at the correct wavelength.

FIG. 2 shows an example of adding the CGH taggants to a projection screen.

FIG. 3 is a block diagram describing the creation of a CGH.

FIG. 4 demonstrates the result if the correct excitation illumination is applied to the taggant.

FIG. 5 is a diagram showing an item with optically-responsive taggants being illuminated by a source that causes the taggants to emit light that can be detected by an optical sensor.

FIG. 6 shows an example of adding the taggants to a projection screen.

FIG. 7 shows the use of spectrally-sensitive taggants.

FIG. 8 demonstrates the result when the correct excitation illumination is applied.

### DETAILED DESCRIPTION

This application is directed to an anticounterfeiting system for projection screens, and more specifically, to an optically-readable taggant system for a projection screen. The taggant is an optically-active layer that is patterned with a design, a code, or an image unique to the screen manufacturer, which is attached to or integrated into the screen. More than one taggant can be used on the same screen with each taggant having the same or different coded optical responses. The system is set up so that the taggant is covert or practically invisible to the naked eye but provides a coded optical response when interrogated by a matched coded optical stimulus to provide a coded optical response that is registered by the detector to authenticate the screen. The coded optical response normally is a design, a code, an image, or combinations thereof, and the detection thereof serves as proof of authenticity of the screen.

In addition to the taggant, the system includes a light source capable of providing a matching coded optical stimulus and a detector capable of detecting the image. In one embodiment, the light source is a laser.

The taggant can be a computer-generated hologram or fragments of a CGH, which CGH fragments themselves can contain a unique pattern. The fragments also can be placed in a predetermined pattern or placed randomly. The taggant can be at least one fluorescent dye, fluorescent ink, fluorescent particle, or mixtures thereof. In one embodiment, the taggant includes nanoparticles made of a lead sulfide core surrounded by an adjacent cadmium sulfide layer and an outer alkane coating layer adjacent to the cadmium sulfide layer. In another embodiment, the taggant can be an optically-transmissive medium with a modulation of an index of refraction. The taggant can be added during the screen fabrication process, or added later.

The matching coded optical stimulus encompasses wavelengths in the visible, ultraviolet, or infrared spectral region. The matching coded optical stimulus includes application of coherent or non-coherent light and the coded optical response is reflected, fluorescing, and/or diffracted light. The matching coded optical stimulus can be ultraviolet light or infrared light.

This disclosure also includes a method of authenticating a projection screen that encompasses interrogating an optical taggant-bearing layer of the screen by applying coherent or non-coherent light to the screen and detecting any reflected and/or diffracted light. In this embodiment, the light can be ultraviolet, infrared, or visible light. In the method, the reflection occurs when the light has a specific wavelength matching the taggant optics. The taggant-bearing layer can be made of a multitude of computer-generated hologram flakes.

In one embodiment, the taggant is a computer-generated hologram (CGH) having a specific code. In another embodiment, the taggant can be multiple fragments of a CGH. The multiple fragments of a CGH can be placed randomly or in a predetermined pattern on or in the screen that can be interrogated in a specifically coded sequence. The CGH fragments themselves may include a specific pattern as well. The positioning and design of the CGH fragments can be selected to avoid any change in the optical, physical, or acoustic performance of the screen.

In another embodiment, the taggant having an optically-active layer is based on fluorescent nanodots or microdots designed to fluoresce only under specific wavelengths. These fluorescent nanodots or microdots fluoresce in the visible spectrum when illuminated by specific wavelengths of ultraviolet or near infrared light, and can be placed randomly or in a predetermined pattern. When implemented with a random pattern, the optically-active layer read-out light is carefully designed to respond to specific peak wavelength, spectral bandwidth and/or time domain (pulse frequency, amplitude and/or modulation) dependence. As above, the positioning and design of the fluorescent nanodots or microdots can be selected to avoid any change in the optical, physical, or acoustic performance of the screen. A typical fluorescent nanoparticle would be a lead-sulfide (PbS) core, with an adjacent cadmium sulfide (CdS) layer and over those two layers would be an alkane coating that would prevent clumping but would be dissolvable in an epoxy solvent or other solvent carrier.

The taggant can be incorporated during the screen fabrication process or can be added later to the screen, The taggant can be in the screen's substrate, on the back or unused surface of the screen, or embedded as a watermark into the screen surface.

Trademarked content, aesthetic patterns, or coding patterns (such as serial numbers that can be validated, positional dependence, and the like) can be used for taggant design. In addition, the taggant can be a surface relief structure.

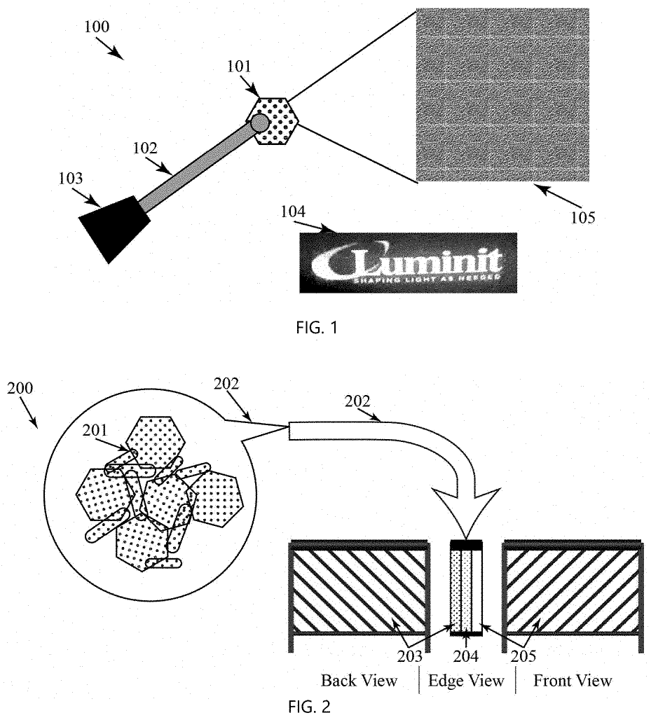

Referring to FIG. 1, a CGH system (100) includes a screen having a taggant of optically-responsive material, a CGH that is spectrally selective (101), which is illuminated (102) by a controlled light source (103). The CGH (101) reflects light (104) at a wavelength, and in a certain pattern that can be detected by an optical sensor (105). This sensor (105) can be, for example, a camera, a videocamera, an infrared photodetector, an eye, or combinations thereof. When the illumination (102) is adjusted to the correct conditions (wavelength, irradiance, or other conditions), the CGH taggant reflects light in a pattern (104) that the optical sensor (105) detects, which confirms the presence of the taggant in the screen and therefore, the authenticity of the screen.

FIG. 2 describes a system (200) where a screen contains a taggant made of CGH fragments (201). These fragments are attached to, or embedded within the screen in a known pattern (202). The taggants may be placed on the back (203) of the screen, or embedded into the screen's substrate (204) without interfering with the operation of the front (205) of the screen. The taggants can be used to authenticate the screen through their reaction to illumination using the conditions needed to cause the CGH fragments to respond. If the CGH fragments are combined within the screen substrate, they can form a watermark that will produce a known pattern at an angle to the screen (on the ceiling or floor, for example) while not interfering with normal screen operation. The CGH fragments can be made spectrally-selective, so that they must be illuminated by a laser at a specific wavelength to produce an image.

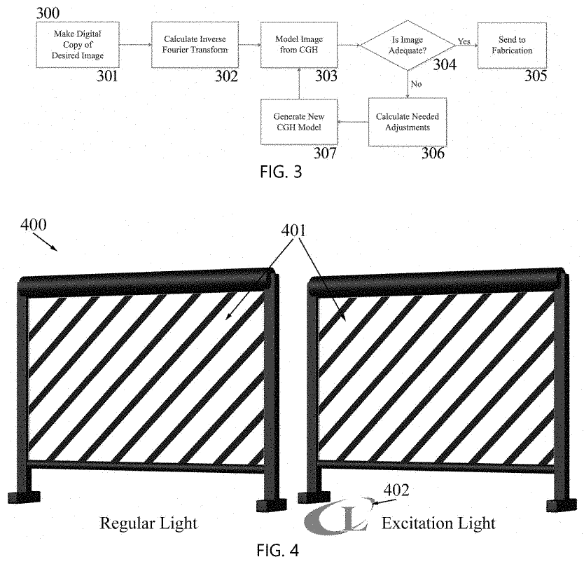

A standard method of creating the CGH itself is shown in FIG. 3. This particular method is the Recursive Inverse Fourier Transform method (300). In this method, the desired image is designed (301) on a computer (or scanned into the computer). The image is treated as a two-dimensional array of numbers; this array is converted using the inverse Fourier transform (302). One embodiment of this process is to use the Fast Fourier Transform algorithm, a standard computer algorithm for calculating both regular and inverse Fourier transforms of digital numerical data. This transformed image is modeled as being a CGH, and a computer routine models the image that the CGH would produce (303) if illuminated by a laser at the correct wavelength. This image is inspected to determine if it will be a sufficient pattern for anticounterfeiting (304). If so, the transformed image (302) is used to produce a CGH (305). If the image needs any changes, these are made in the computer (306). The new transformed image is then modeled as a CGH (307). It is then returned to the routine (303) that produces the pattern that this new transformed image would produce if it were a CGH illuminated by a laser. Steps 306-307-303-304 are repeated until the image is adequate for the needs of the pattern, at which point it is used to produce the final CGH pattern (305).

FIG. 4 shows an anticounterfeiting system (400) having a screen (401) under regular light, which may include its operation as a projection screen or can be the back side of the screen, and the same screen illuminated by light at the correct wavelength for reflection from the CGH. This CGH may produce a pattern such that excitation light causes the taggant to reflect detectable light in a verifiable shape (402), such as the logo of a manufacturing company, at a location away from the screen itself.

FIG. 5 illustrates a system (500) that includes a projection screen having a taggant (501) that includes an optically-responsive material, such as a fluorescent dye, fluorescent microscopic spheres, fluorescent nanoparticles, a medium with varying refractive index, or mixtures thereof that is being illuminated (502) by a controlled light source (503). The optically-responsive material emits light (504) at a wavelength that can be detected by an optical sensor (505). This sensor may be, for example, a camera, a videocamera, an infrared photodetector, an eye, or combinations thereof. When the illumination (502) is adjusted to the correct conditions (wavelength, irradiance, or other conditions), the optically-responsive material emits light (504) that demonstrates its inclusion in the item, which provides assurance that the item is genuine and not counterfeit.

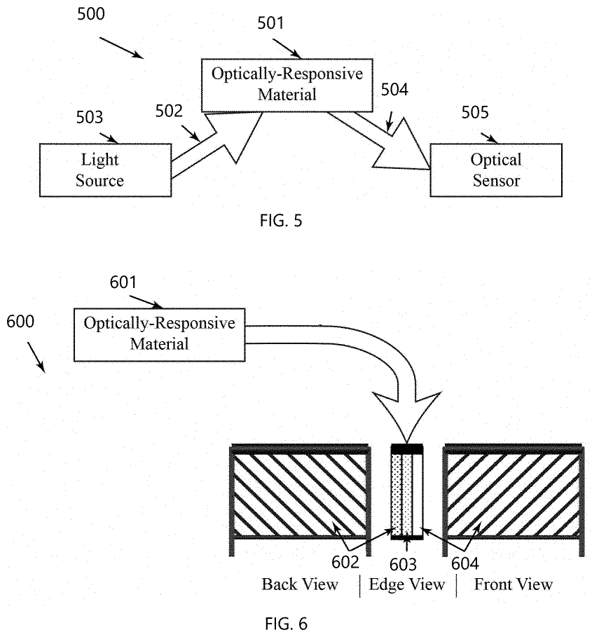

FIG. 6 describes a system (600) where a screen contains an optically-responsive material (601). This material may be placed on the back (602) of the screen, or in the screen's substrate (603), without interfering with the operation of the front (604) of the screen. This embedded material can be used to authenticate the screen through its reaction to illumination using the conditions needed to cause the material to respond.

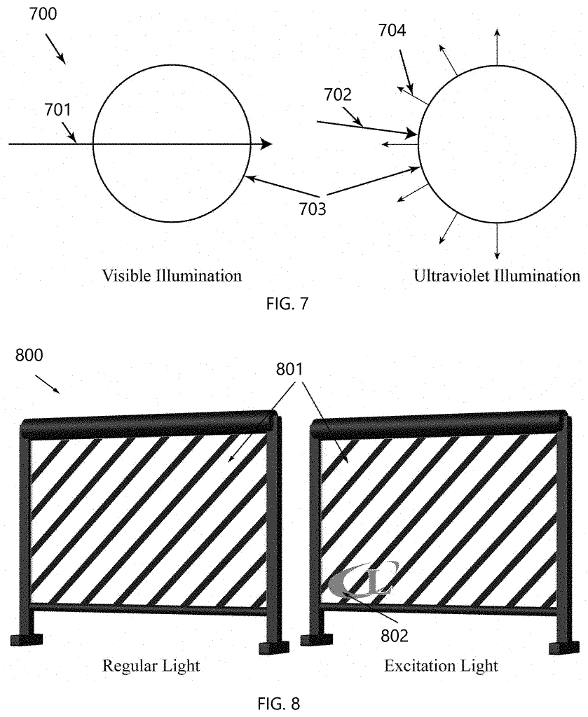

FIG. 7 corresponds to a taggant (700) applied using a spectrally-selective optically-responsive material, such as fluorescent nanodots (703). When the screen illumination, or the taggant illumination, is in the visible spectrum (701), the taggant does not respond. If the taggant is illuminated with light at the correct wavelength (702), usually in the ultraviolet spectral region, it emits light (704) at a different wavelength that can be detected by an optical sensor or an eye.

FIG. 8 shows a screen (801) under regular light, which may include its operation as a projection screen (800), and the same screen illuminated by light at the correct wavelength for exciting the taggant material. This material may be applied in a pattern such that excitation light causes the taggant to emit detectable light in a verifiable shape (802), such as the logo of a manufacturing company.

An embodiment of this invention is also a transparent layer where the taggant is a modulation of the refractive index. Like phase holographic optical elements that are based on controlled perturbations of the refractive index of a volume, any optical function can be encoded using the index modulation. In this embodiment, the index modulation would have encoded within either a logo or other trademarked or recognizable image and/or codes that enable verification of authenticity. These index modulation-based codes are recorded outside of the parameters of cinema operations (i.e. different wavelength, divergence and/or angular range) to facilitate authentication without affecting the normal use of the projection screen.

While the disclosed subject matter has been described in conjunction with a number of embodiments, it is evident that many alternatives, modifications, and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. An anticounterfeiting system for a projection screen comprising:
(a) a taggant comprising an optically-active layer of material patterned with a design, a code, or an image;
(b) a light source capable of providing a matching coded optical stimulus; and
(c) a detector
wherein the taggant is embedded in or attached to the projection screen and is detectable by interrogating the taggant with the matched coded optical stimulus to provide a coded optical response that is registered by the detector to authenticate the screen.

2. The anticounterfeiting system of claim 1 wherein the taggant is covert or practically invisible to the naked eye but provides a coded optical response when interrogated by a matched coded optical stimulus.

3. The anticounterfeiting system of claim 1 wherein the coded optical response comprises a design, a code, an image, or combinations thereof.

4. The anticounterfeiting system of claim 1 comprising more than one taggant on the same screen with each taggant having the same or different coded optical responses.

5. The anticounterfeiting system of claim 1 wherein the taggant comprises a single entity or multiple entities.

6. The anticounterfeiting system of claim 1 wherein the taggant comprises a computer-generated hologram.

7. The anticounterfeiting system of claim 1 wherein the taggant comprises at least one fluorescent dye, fluorescent ink, fluorescent particles, or mixtures thereof.

8. The anticounterfeiting system of claim 1 wherein the taggant comprises nanoparticles comprised of a lead sulfide core surrounded by an adjacent cadmium sulfide layer and an outer alkane coating layer adjacent to the cadmium sulfide coating layer.

9. The anticounterfeiting system of claim 1 wherein the matching coded optical stimulus comprises wavelengths in the visible, ultraviolet, or infrared spectral region.

10. The anticounterfeiting system of claim 1 wherein the matching coded optical stimulus comprises application of coherent or non-coherent light and the coded optical response comprises reflected, fluroescing, and/or diffracted light.

11. The anticounterfeiting system of claim 1 wherein the matching coded optical stimulus comprises ultraviolet light or infrared light.

12. The anticounterfeiting system of claim 1 wherein the light source comprises a laser.

13. The anticounterfeiting system of claim 1 wherein the taggant comprises an optically-transmissive medium with a modulation of an index of refraction.

14. The anticounterfeiting system of claim 1 wherein the taggant comprises fragments of a CGH, which fragments can be placed randomly or in a predetermined pattern in or on the screen.

15. The anticounterfeiting system of claim 1 wherein the taggant comprises fragments of a CGH, which CGH fragments themselves comprise a unique pattern.

16. The anticounterfeiting system of claim 1 wherein the taggant is added during the screen fabrication process, or later.

17. A method of authenticating a projection screen comprising interrogating a taggant-bearing layer of the screen having certain optics by applying coherent or non-coherent light to the layer of the screen and detecting any reflected and/or diffracted light.

18. The method of claim 17 wherein the light comprises ultraviolet, infrared, or visible light.

19. The method of claim 17 wherein reflection only occurs when the light comprises a specific wavelength matching the taggant optics.

20. The method of claim 17 wherein the taggant-bearing layer comprises a multitude of computer-generated hologram flakes.
